(19) United States
(12) Patent Application Publication
(10) Pub. No.: US 2006/0278241 A1
(43) Pub. Date: Dec. 14, 2006

(54) Physiogenomic method for predicting clinical outcomes of treatments in patients

(76) Inventor: Gualberto Ruano, Milford, CT (US)

Correspondence Address: MORGAN & FINNEGAN, L.L.P., 3 WORLD FINANCIAL CENTER, NEW YORK, NY, 10281-2101, US

(21) Appl. No.: 11/010,716

(22) Filed: Dec. 14, 2004

(51) Int. Cl. G06Q 50/00; G06F 19/00

(52) U.S. Cl. 128/898; 702/20; 705/3

(57) ABSTRACT

A physiogenomic-based method for predicting the outcome of treatment regimens in human patients based upon association screening to identify genetic markers and related physiological characteristics that influence the disease status of a patient, the progression to disease and response to the treatment. By repeating the analysis quantitatively for each of multiple treatment regimens, a profile can be created for each patient can be used to determine which of several treatment regimens are best suited to the patient's clinical needs.

### FIELD OF THE INVENTION

In general, the field of the invention is physiogenomics. More specifically, the invention comprises a physiotype method for predicting the results of treatment regimens in a patient.

### BACKGROUND

Although clinically highly relevant, physiology has remained a systems and macroscopic embodiment of scientific thought separate from the molecular basis of genetics. The physiogenomics method of the present invention bridges the gap between the systems approach and the genomic approach by using human variability in physiological process, either in health or disease, to drive their understanding at the genome level. Physiogenomics is particularly relevant to the phenotypes of complex diseases and the clustering of phenotypes into domains according to measurement technique, ranging from functional imaging and clinical scales to protein serology and gene expression.

Physiogenomics integrates genotypes, phenotypes and population analysis of functional variability among individuals. In physiogenomics, allelic genetic markers (single nucleotide polymorphisms or “SNPs”, haplotypes, insertion/deletions, tandem repeats) are analyzed to discover statistical associations to physiological characteristics in populations of individuals either at baseline or after they have been similarly exposed or challenged to environmental triggers. These environmental challenges span the gamut from exercise and diet to drugs and toxins, and from extremes of temperature, pressure and altitude to radiation. In the case of complex diseases we are likely to find both baseline characteristics and response phenotypes to as yet undetermined environmental triggers. Variability in a genomic marker among individuals that tracks with the variability in physiological characteristics establishes associations and mechanistic links with specific genes.

Physiogenomics integrates systems engineering with molecular probes stemming from genomic markers available from industrial technologies. The physiogenomic method of the invention marks the entry of genomics into systems biology, and requires novel analytical platforms to integrate the data and derive the most robust associations. Once physiological systems are under scrutiny, the industrial tools of high-throughput genomics do not suffice, as fundamentals processes such as signal amplification, functional reserve and feedback loops of homeostasis must be incorporated.

The inventive physiogenomics method includes marker discovery and model building. Each of these interrelated components will be described in a generic fashion. Reduction to practice of the generic physiogenomic invention will then be demonstrated by our experimental data in the Examples section.

### SUMMARY OF THE INVENTION

A physiogenomic method for predicting whether or not a particular treatment regimen will produce a beneficial effect on a human patient, comprising, first, conducting association screening to identify genetic markers (SNP's, haplotypes, insertion/deletions, tandem repeats) and physiological characteristics that have an influence on the disease status of the patient or the response to treatment by the steps of:
(a) identifying significant covariates among demographic data and the other phenotypes and delineating correlated phenotypes by principal component analysis;
(b) performing for each selected genetic marker an unadjusted association test using genetic data and linear regression for phenotypes reflective of the disease and baseline states of the patient;
(c) using permutation testing to obtain a non-parametric and marker complexity probability (“p”) value to identify significant markers, wherein significance is shown by a p<0.05;
(d) constructing a validated model by linear regression analyses and model parameterization for the dependence of said patient's response to treatment on the markers, wherein a valid model is one with a p<0.05; and,
(e) identifying one or more genes not associated with a particular outcome in said patient to serve as a physiogenomic control.

In an example of the utility of the invention, apolipoprotein E (APOE) haplotypes are used to predict the outcome of exercise training on serum lipid profiles, such as low density lipoprotein cholesterol (LDL-C), high density lipoprotein cholesterol (HDL-C) and lipoprotein particle size distributions.

In another example of the utility of the invention, apolipoprotein A1 (APOA1) genotypes are used to predict the outcome of exercise training on serum lipid profiles, such as LDL-C, HDL-C and lipoprotein particle size distributions.

In still another example of the utility of the invention, genotypes for cholesterol ester transfer protein (CETP), angiotensin converting enzyme (ACE), lipoprotein lipase (LPL), hepatic lipase (LIPC), and peroxisome proliferator-activated receptor-alpha (PPARA) are provided.

In still another embodiment of the invention, cardiovascular inflammatory markers in blood are associated with exercise training, with genetic probes being derived from candidate genes relevant to energy production, inflammation, muscle structure, mitochondrial oxygen consumption, blood pressure, lipid metabolism, and behavior, as well as transcription factors potentially influencing multiple physiological axes.

In yet another embodiment of the invention, phenotypes related to plasma concentrations of interleukins and growth factors and cellular expression of ligand receptors are added to the analysis.

In still another embodiment of the invention, a physiogenomic profile is created for a patient by combining the genomic data for the patient with the patient's clinical and physiological data for each possible treatment modality, said profile serving to provide a logical basis for selecting the most efficacious treatment(s) for the patient.

### DETAILED DESCRIPTION OF THE PREFERRED EMBODIMENTS

A physiogenomic method for predicting whether or not a particular treatment regimen will have a beneficial outcome in a patient has been invented. The physiogenomic aspect of the method consists of determining genetic markers that are associated with beneficial effects of a particular treatment regimen, and then selecting patients for treatment who present with the beneficial genotype. The physiotype aspect of the method consists of establishing a treatment profile for the patient by combining the aforementioned genomic data with physiological and clinical data for the same patient for each of a set of possible treatments for the patient's medical condition, so as to customize interventions for the patient.

The following definitions will be used in the specification and claims:
1. Correlations or other statistical measures of relatedness between genotypes and physiologic parameters are as used by one of ordinary skill in this art.
2. As use herein, “polymorphism” refers to DNA sequence variations in the cellular genomes of animals, preferably mammals. Such variations include mutations, single nucleotide changes, insertions and deletions. Single nucleotide polymorphism (“SNP”) refers to those differences among samples of DNA in which a single nucleotide pair has been substituted by another.
3. As used herein, “variants” is synonymous with polymorphism.
4. As used herein, “phenotype” refers to any observable or otherwise measurable physiological, morphological, biological, biochemical or clinical characteristic of an organism. The point of genetic studies is to detect consistent relationships between phenotypes and DNA sequence variation (genotypes).
5. As used herein, “genotype” refers to the genetic composition of an organism. More specifically, “genotyping” as used herein refers to the analysis of DNA in a sample obtained from a subject to determine the DNA sequence in one or more specific regions of the genome, for example, at a gene that influences a disease or drug response.
6. As used herein, “haplotype” refers to the partial or complete sequence of a segment of DNA from a single chromosome. The DNA segment may include part of a gene, an entire gene, several genes or a region devoid of genes (but which contains segments that may influence a neighboring gene). The term “haplotype” then refers to a cis arrangement of two or more polymorphic nucleotides in a particular gene. The haplotype preserves information about the phase of the polymorphic nucleotides, that is, which set of variances were inherited from one parent (and therefore are on one chromosome) and which from the other.
7. As used herein, the term “associated with” in connection with a relationship between a genetic marker (SNP, haplotype, insertion/deletion, tandem repeat) and a phenotype refers to a statistically significant dependence of marker frequency with respect to a quantitative scale or qualitative gradation of the phenotype.
8. As used herein, a “gene” is a sequence of DNA present in a cell that directs the expression of biochemicals, i.e., proteins, through, most commonly, a complementary RNA.
9. As used herein, the expression “physiotype” is used to describe a treatment profile for a patient with a particular medical condition that is created by combining physiological and clinical data for the patient with the patient's genomic data for each possible treatment regimen, the profile being used to select which treatment or treatments would be most efficacious for the patient.
10. “BMI” refers to body mass index.

### Physiogenomics

A. Determining Physiogenomic Markers by Association Screening

The first step in the inventive method is to identify physiogenomic markers by association screening. The purpose of association screening is to identify any of a large set of genetic markers (SNPs, haplotypes, insertion/deletions, tandem repeats) and physiological characteristics, i.e., factors that have an influence on the disease status of the patient, the progression to disease or the response to treatment. The association between each physiogenomic factor and the outcome will be calculated using logistic regression models, controlling for the other factors that have been found to be relevant. The magnitude of these associations will be measured with the odds ratio. Statistical significance of these associations will be determined by constructing 95% confidence intervals. Multivariate analyses will be used which include all factors that have been found to be important based on univariate analyses. Because the number of possible comparisons can become very large in analyses that evaluate the combined effects of two or more genes, we will include in our results a random permutation test for the null hypothesis of no effect for two through five combinations of genes. This test will be performed by randomly assigning phenotypes to each individual in the study. Random associations of phenotypes and genotypes of the invidividuals are implied by the null distribution of no genetic effect. A test statistic can be calculated that corresponds to the null hypothesis of the random combination effects of genotypes and phenotypes. Repeating this process 1000 times will provide an empirical estimate of the distribution for the test statistic, and hence a p-value that takes into account the process that gave rise to the multiple comparisons. In addition, once can consider hierarchical regression analysis to generate estimates incorporating prior information about the biological activity of the gene variants. In this type of analysis, multiple genotypes and other risk factors can be considered simultaneously as a set, and estimates will be adjusted based on prior information and the observed covariance, theoretically improving the accuracy and precision of effect estimates.

A single association test will proceed in 3 steps:

(Step 1) Covariates

The purpose of this step is to identify significant covariates among demographic data and the other phenotypes and delineate correlated phenotypes by principal component analysis. Covariates are determined by generating a covariance matrix for all markers and selecting each significantly correlated markers for use as a covariate in the association test of each marker. Serological markers and baseline outcomes are tested using linear regression.

(Step 2) Associations

The purpose of this step is to perform an unadjusted association test, linear regression for serum levels and baselines). Tests should be performed on each marker, and markers that clear a significance threshold of p<0.05 are selected for permutation testing.

(Step 3) Multiple Comparison Corrections

In this step a non-parametric and marker complexity adjusted p-value are generated by permutation testing. This procedure is important because the p-value is used for identifying a few significant markers out of the large number of candidates. Model-based p-values are unsuitable for such selection, because the multiple testing of every potential serological marker and every polymorphic marker will be likely to yield some results that appear to be statistically significant even though they occurred by chance alone. If not corrected, such differences will lead to spurious markers being picked as the most significant. A correction will be made by permutation testing, i.e., the same tests will be performed on a large number of data sets that differ from the original by having the response variable permuted at random with respect to the marker, thereby providing a nonparametric estimate of the null distribution of the test statistics. The ranking of the non-permuted test result in the distribution of permuted test results will provide a non-parametric and statistically rigorous estimate of the false positive rate for this marker. For permutation testing, a large number (e.g., 1000) of permutated data sets are generated, and each candidate marker is retested on each of those sets. A p-value is assigned according to the ranking of the original test result within the control results. A marker is selected for model building when the original test ranks within the top 50 of the, for example, 1000 (p<0.05).

(Step 4) Genomic Controls and Negative Results

Each gene not associated with a particular outcome effectively serves as a negative control, and demonstrates neutral segregation of non-related markers. The negative controls altogether constitute a “genomic control” for the positive associations where segregation of alleles tracks segregation of outcomes. By requiring the representation of the least common allele for each gene to be at least 10% of the population, one can rule out associations clearly driven by statistical outliers. Negative results are thus particularly useful in physiogenomics. To the extent that specific candidate genes are not linked to phenotypes, one can still gain mechanistic understanding of complex systems, especially for segregating the influences of the various candidate genes among the various phenotypes.

B. Construction of Physiogenomic Models

(Step 1) Model Building

The next stage in the inventive method is physiogenomic modeling. Once the associated markers have been determined, a model is built for the dependence of response on the markers. In the first phase, linear regression models of the following form are preferably used:

$$R = {R}_{0} + {\sum }_{i} {α}_{i} {M}_{i} + {\sum }_{i} {β}_{i} {D}_{i} + ɛ$$

where R is the respective phenotype variable (e.g., BMI), Mᵢ represents the marker variables, Dᵢ are demographic covariates, and ε is the residual unexplained variation. The model parameters that are to be estimated from the data are Rₒ, αᵢ and βᵢ.
(Step 2) Model Parameters

The models built in the previous step will include parameters based on the data. The maximum likelihood method is preferably used, as this is a well-established method for obtaining optimal estimates of parameters.

In addition to optimizing the parameters, model refinement may be performed. In the first phase linear regression model, this consists of considering a set of simplified models by eliminating each variable in turn and re-optimizing the likelihood function. The ratio between the two maximum likelihoods of the original compared to the simplified model then provides a significance measure for the contribution of each variable to the model.

(Step 3) Model Validation

A cross-validation approach is used to evaluate the performance of models by separating the data used for parameterization (training set) from the data used for testing (test set). A model to be evaluated is readjusted with parameters derived using all data except for one patient. The likelihood of the outcome for this patient is calculated using the outcome distribution from the model. The procedure is repeated for each patient, and the product of all likelihoods is computed. The resulting likelihood is compared with the likelihood of the data under the null model (no markers, predicted distribution equal to general distribution). If the likelihood ratio is p<0.05, the model should be evaluated as providing a significant improvement of the null model. If this threshold is not reached, the model is not sufficiently supported by the data, which could mean either that there is not enough data, or that the model does not reflect actual dependencies between the variables.

Physiotypes for various treatments are used for decision support in a menu driven format (see Example 6, below). For achieving a desired therapeutic outcome for a given patient, physiotypes for each of the various treatment alternatives (exercise, drugs, and diet) are applied to predict quantitatively the patient's response for each. To derive the physiotypes, physiological and clinical data gathered by the physician and genomic data from several genetic markers, are combined to produce an intervention profile menu. Predictions made by the physiotype will rank the best alternatives among the menu options to achieve a desired goal. As more options are built into the menu, the greater the chance that all patients will be served with increased precision of intervention and with optimal outcome.

As long as the appropriate physiogenomics research has been performed for each intervention in the menu, an individual's physiotypes would evaluate all possibilities for optimized healthcare. The clinician can query for simple indexes such as raising HDL, or lowering triglycerides or compounded indexes such as LDL/HDL ratios or simultaneous elevation of HDL and reduction of TG. Physiotypes are derived for each intervention to predict a single effect or combined outcomes, and the same decision-making process can proceed seamlessly.

Models can be created by the method of the invention that predict various lipid, inflammatory and anthropometric responses to diet, exercise and drugs.

The baseline physiological and clinical level is measured for several phenotypes ranging from serology, physical exam, imaging, endocrinology for genomic/proteomics markers. The response of each individual for the phenotypes is then acquired after the exposure. Physiogenomics utilizes variability in response in the cohort to derive the predictors of response. After the physiotypes have been established for each given intervention, they can be applied to predict the response of a new individual to the intervention.

The medical utility of the invention will depend on the range of options it can customize. Within each of the major treatment modes (exercise, drug and diet), alternatives should be available to achieve specified goals. For example, consider dietary intervention to raise HDL in a patient with metabolic syndrome, and a decision on whether to proceed with a low fat or low carbohydrate diet. With physiotypes discovered each for low fat and low carbohydrate diets, predictions can be drawn for an individual's response to either. The person's physiological and genetic markers would be entered into the physiotypes, and the best diet based on the physiotype's prediction can be identified for the individual. Physiotypes can be generated, not only for various kinds of diet, but also for various kinds of exercise and drug treatments. The menu of possible interventions is thus broadened. The physiotype yielding the best outcome for a given desired effect guides the mode of intervention from an increasingly diversified menu, thus allowing enhanced personalization and customization of treatment.

It is within the scope of the present invention to produce for a given patient in permanent printed form a record of the prognostic results of his/her physiogenomic analyses disclosed above. This profile will become part of the patient's records. The printed form may be produced by any means, including a computer-generated printout.

We have applied the physiogenomic prognostic method described above to several treatment regimens, including those described below in the Examples section. Examples are designed to illustrate the inventive method, and should not be interpreted as limiting the scope of the invention, which is limited only by the claims attached.

### EXAMPLES OF REDUCTION TO PRACTICE

### Example 1

### Determination of Sample Size

In order to determine the sample size requirements for a study, preliminary data is obtained and the percent change in BMI with treatment is assessed. For example, the standard deviation for percent change in BMI among the subjects was 5%. Table 1 shows the total sample size required plotted against the prevalence of the physiogenomic prevalence to detect a given percent change in BMI using a 5% two-tailed test with 80% power. This demonstrates that a study with 150 subjects should have sufficient power to detect a mean difference of 2.5% BMI if the factor prevalence is between 25% and 75% of the population and 3.0% if between 10% and 90%.

TABLE 1
Sample size required by percent change in BMI for 5%
significance level and 80% power at gene marker frequencies
between 25% and 75% in the sample population

| Percent BMI Change | Sample Size |
|---|---|
| 2.5 | 150 |
| 3.0 | 100 |
| 4.0 | 60 |
| 5.0 | 40 |

### Example 2

### Physiogenomics of Exercise

The inventive method was tested by examining the effects of exercise on lipid profiles, as a function of the genotypes of seven marker biochemicals that are known to be involved in lipid metabolism and serum lipid levels. We correlated the exercise responses as measured by various outcomes with the variability of selected candidate genes. The candidate genes were selected according to known mechanisms of cholesterol homeostasis and the exercise response. The candidate genes and the candidate genotypes are shown in Table 2. The genes and their abbreviations are: apolipoprotein E (APOE), apolipoprotein A1 (APOA1), cholesterol ester transfer protein (CETP), angiotensin converting enzyme (ACE), lipoprotein lipase (LPL), hepatic lipase (LIPC), and peroxisome proliferator-activated receptor-alpha (PPARA). Other genes analyzed were ATP-binding cassette, sub-family G (WHITE), member 5 (sterolin 1) (ABCG5) and cholesterol 7-alpha hydroxylase gene (CYP7).

TABLE 2

| | Candidate | |
|---|---|---|
| Genes | Genetic Markers | References |
| APOE | Haplotype E2, E3, E4 | Thompson P D, et al., |
| | | Metabolism 53: 193-202 (2004) |
| APOA1 | SNP −75 G/A | Marin, C et al., Am. J. |
| | | Clin. Nut.r 76: 319 (2002) |
| CETP | SNP −629 C/A | Tai, E S et al., Clin. |
| | | Genet. 63: 19 (2003) |
| LPL | SNP −93 T/G | Corella et al., J. Lipid |
| | S447X (CtoG) | Res. 43: 416-427 (2002) |
| LIPC | SNP −514 C/T | Ordovas, J M et al., |
| | | Circulation 106: 2315 (2002) |
| ACE | Insertion/ | Rankinen T, et al., J. Appl. |
| | Deletion I/D 287 | Physiol. 88: 1029-1035 (2000) |
| PPAR | SNP Leu162Val | Tai, E S et al. Clin. |
| | | Genet. 63: 19 (2003) |

A preferred method for obtaining additional genotypes is the BeadStation 500GX system (Illumina, Inc., 9885 Towne Creek Center Drive, San Diego, Calif. 02121). This is an integrated system that supports highly parallel SNP genotyping and RNA profiling applications on a single, high-performance platform that delivers a scalable range of sample throughput.

### Example 3

### Exercise Physiogenomics Incorporating APOE Genetic Markers

The experiments explored the inventive concept that APOE variability is related to lipid changes with exercise training. To this end, three equal cohorts with subjects having the most common APOE haplotype pairs in the general population, APOE 2/3, 3/3, and 3/4, were recruited. To control for this design characteristic, APOE haplotype was utilized as covariate for the analysis of the other genetic markers, and was found not to be associated, thus demonstrating that none of the other genetic markers were in physical linkage with APOE and assorted randomly in the three cohorts. Variability in each gone was measured by a genetic polymorphism with a frequency of at least 10%. Such sampling establishes three groups of individuals for each gene: homozygous for either allele or heterozygous.

TABLE 3
Physiogenomics data analysis and screening for
associations of gene marker and phenotypes

| Lipids | | | | | | | Physiological | | | |
|---|---|---|---|---|---|---|---|---|---|---|
| A | B | C | D | E | F | G | H | I | J | Phenotype |
| 4 | 0 | 3 | 23 | 2 | 5 | 1 | 27 | 30 | 0 | APOE |
| 4 | 3 | 1 | 5 | 3 | 16 | 17 | 25 | 23 | 3 | PPARA |
| 0 | 3 | 4 | 6 | 0 | 27 | 0 | 7 | 3 | 11 | LIPC |
| 0 | 0 | 3 | 0 | 3 | 2 | 4 | 1 | 5 | 16 | LPL |
| 21 | 32 | 21 | 0 | 1 | 2 | 11 | 2 | 3 | 6 | APOA1 |
| 9 | 5 | 0 | 0 | 23 | 5 | 3 | 9 | 12 | 11 | CETP |
| 4 | 6 | 5 | 2 | 1 | 1 | 0 | 3 | 1 | 2 | ACE |
| 1 | 2 | 0 | 1 | 5 | 8 | 9 | 1 | 0 | 0 | ABCG5 |
| 2 | 2 | 3 | 4 | 6 | 0 | 4 | 0 | 2 | 2 | CYP7 |

TABLE 4
Summary of highest ranked association results from Table 3

| Column | Gene | Phenotype | Adj P | In Count | Out Count |
|---|---|---|---|---|---|
| B | APOA1 | CHGSMHDL | 32 | 22 | 53 |
| I | APOE | VMAXLCHG | 30 | 42 | 77 |
| H | APOE | VMXMLCHG | 27 | 42 | 77 |
| F | LIPC | CHGAPOB | 27 | 6 | 83 |
| H | PPARA | VMXMLCHG | 25 | 11 | 89 |
| D | APOE | CHGL2M | 23 | 40 | 66 |
| I | PPARA | VMAXLCHG | 23 | 11 | 89 |
| E | CETP | CHGLDLSZ | 23 | 44 | 25 |
| C | APOA1 | CHGH345 | 21 | 22 | 53 |
| A | APOA1 | CHGV56 | 21 | 22 | 53 |
| G | PPARA | CHGHLA | 17 | 11 | 86 |
| F | PPARA | CHGAPOB | 16 | 11 | 90 |
| J | LPL | CHGBMI | 16 | 18 | 64 |

The code letters and names for the phenotypes in Tables 3 and 4 are defined as:
A CHGV56=change in VLDL subpopulations V5 and V6 (i.e., largest VLDL particles)
B CHGSMHDL=Change in small HDL
C CHGH345=change in large HDL cholesterol
D CHGL2M=change in medium LDL particle concentration
E CHGLDLSZ=change in LDL diameter (this is the mean for entire LDL population)
F CHGAPOB=change in apo B
G CHGHLA=change in hepatic lipase activity
H VMXMLCHG=change in VO2 max, mL O2 per kg BW per minute
I VMAXLCHG=change in VO2 max, Liters per minute
J CHGBM1=change in Body Mass Index (BMI)

The basis of the statistical analysis in physiogenomics is a parallel search for associations between multiple phenotypes and genetic markers for several candidate genes. The summary in Table 3 depicts the data set gathered from the initial application to exercise physiogenomics. In the top panel, each column represents a single phenotype measurement. Each row represents alleles for a given gene, and quantitatively render associations of specific alleles to the variability in the phenotype. The various numbers in the table refer to the negative logarithms of p value times 10. These p values are adjusted for multiple comparisons using the nonparametric permutation test described earlier. For example, 30 refers to a p value of <0.001. Because of the large numbers of genes and outcomes that can be found, an interactive program can be prepared that can be used to search a large table with a structure similar to that shown in Table 3. As already noted, the p-value displayed in a cell is generated under the assumption of a linear trend for the effect of an intervention.

The platform allows visual recognition of highly significant association domains. There are also clearly negative fields. The same gene is associated to some phenotypes but not to others Similarly, a given phenotype may have associations to some genes, but not others. Each negative result lends power to the positive associations. Had the populations related to a phenotype being stratified based on confounder founder effects, most genes would have had specific founder alleles overrepresented in that population, and associated with similarly stratified founder phenotypes.

Tables 4 above provides information on the association grid. The table lists in order of significance the “hits” of positive association between a gene alleles and a phenotype. The top ranking associations refer to APOA1 and CHGSMH, change in cholesterol, small HDL sub-fraction change (adjusted p of 32 or p<10^{-3.2}). Noteworthy also are high ranking associations of APOE to VMAXLCHG, change in maximum oxygen consumption (adjusted p of 30 or p<10⁻³) and to CHGL2M (adjusted p of 23 or p<10^{-2.3}). The “InCount” represents individuals with the associated allele, and the “OutCount”, individuals without. The counts among various phenotypes may be different depending on measurement sampling during the study. Well represented distributions among the “in” and “out” groups to assure that a given association is not being driven by outliers. In the case of rare side effects, the outliers actually represent the susceptible population associated with a lower frequency predictive marker.

The initial analysis yielded several associations.
Changes in serum lipids were related to APOE haplotype. Specifically, changes in the ratios of lower density lipoprotein to HDL, were greater in the APOE haplotype 3/3 subjects than in those subjects with haplotypes 2/3 and 3/4. This demonstrates that the lipid response to an environmental challenge, exercise training, is influenced by APOE haplotype.
Despite the more favorable lipid response to exercise training, the increase in exercise performance was less in the APOE haplotype 3/3 subjects than in the other two genetic groups. This is a novel observation, but suggests that genes related to lipid metabolism affect the increase in exercise performance with exercise training. These results are consistent with animal studies showing reduced exercise capacity and muscle amyloid accumulation in APOE-deficient mice.
The response of the LDL and HDL lipid subfractions to exercise also varied by APOE haplotype. Reductions in small dense LDL, an atherogenic particle, were greatest in APOE haplotype 3/3 subjects.
APOA1 genotypes correlate with a switch of small to large HDL particles in some individuals and of large to small HDL particles in others. The direction of the switch in a given individual correlates with APOA1 genotype.

Small dense LDL particles are atherogenic. Therefore lipoprotein particle subpopulations were analyzed in 106 subjects. Exercise decreased small LDL particle concentration by −13.7±5.1 mg/dL selectively in those with the APOE 3/3 haplotypes, compared to increases of +5.6±5.2, and +12.6±5.6 mg/dL, respectively, in those with 2/3 and 3/4 haplotypes. Surprisingly, maximal oxygen uptake, the best marker of aerobic fitness, increased 9-10% for the entire cohort, but only 5% in the 3/3 subjects vs. 13% in the 2/3 and 3/4 groups. This difference in the response of exercise performance to exercise training was significantly different among the haplotypes (p<0.01 for changes). Thus, subjects with APOE 3/3 haplotypes, the most common APOE haplotype in the general population, experienced greater improvement in clinically relevant lipid parameters compared to subjects with APOE haplotypes 2/3 and 3/4, despite smaller improvements in cardiorespiratory fitness.

### Example 4

### Exercise Physiogenomics Incorporating APOA1 Genetic Markers

ApoA1 is necessary for nascent HDL generation. Tables 3 and 4 above also demonstrate APOA1 genetic association to Cholesterol (CH) values (LDL, HDL and their sub-fractions). The APOA1 gene has a well characterized SNP in its promoter, namely, −75 G/A. The data demonstrates that this variant was highly predictive of changes in the concentrations of small and large HDL particles with exercise training. Exercise markedly affects HDL fractions, eliciting a transition from small to large HDL in some individuals and the opposite in others. The presence of the A allele was associated with increased small HDL by 4.7 mg/dL with exercise and decreased large HDL. In contrast, the G/G genotype was associated with increased large HDL concentration by 1.8 mg/dL and decreased small HDL particles. ApoA1 appears to be involved in the switch in particle size in response to exercise and the −75A allele of APOA1 is a potential predictor of the polarity of the HDL fraction switch in response to exercise. When translated into a DNA diagnostic, would be useful for the individualization of exercise programs to effect desired changes in lipid profiles of individuals.

### Example 5

### Results of Model Building

To illustrate the creation of predictive models that are the central part of physiogenomics, the data set was explored to find optimally predictive linear regression models for small LDL particle concentration and small HDL particle concentration. These two response variables have the strongest genetic component observed herein.

The objective of these analyses is to search for genetic markers that modify the effect produced by a particular type of intervention, which epidemiologists refer to as an effect modifier. These are be parameterized in our models as gene-intervention interactions. For example, if Mᵢ is a 0 or 1 indicator of the presence of at least one recessive allele of gene i, and Xⱼ represents the level of intervention, then the entire contribution to the outcome will be given by the contribution of not only the gene and intervention main effects, but their interaction, as well, i.e., Mᵢαᵢ+Xⱼβⱼ+MᵢXⱼ (αβ)ᵢⱼ. Under this model, when the allele is absent (Mᵢ=0), the effect of a unit change in the intervention is described by the slope, βⱼ, but when the allele is present (Mᵢ=1), the effect of a unit change in the intervention is βⱼ+(αβ)ᵢⱼ. Thus, the gene-intervention interaction parameter, (αβ)ᵢⱼ, represents the difference in the effect of the intervention seen when the allele is present.

In the usual modeling framework, the response is assumed to be a continuous variable in which the error distribution is normal with mean 0 and a constant variance. However, it is not uncommon for the outcomes to have an alternative distribution that may be skewed, such as the gamma, or it may even be categorical. In these circumstances, one can make use of a generalized linear model, which includes a component of the model that is linear, referred to as the linear predictor, thus enabling one to still consider the concept of a gene-intervention interaction, as described earlier. The advantage of this broader framework is that it allows for considerable flexibility in formulating the model through the specification of the link function that described the relationship between the mean and the linear predictor, and it also provides considerable flexibility in the specification of the error distribution, as well (McCullagh P, et al. Generalized Linear Models. London: Chapman and Hall, 1989, which is incorporated herein by reference).

To this point, an analysis has been developed in which the effect of the intervention is assumed to be linear, but in practice the effect may take place until a threshold is past, or it may even change directions. Thus, an important component of one's exploration of the intervention effect on a particular response may involve the form for the relationship. In this case one can make use of generalized additive models (GAMs, Hastie et al. Stat. Sci. 1:297 (1986)) in which the contribution of the marker and intervention is given by Mᵢαᵢ+β(Xⱼ)+Mᵢβ_{α}(Xⱼ). In this case, the effect when the allele is absent (Mᵢ=0) is β(Xⱼ) which is an unspecified function of the level of the intervention. In subject in which the allele is present (Mᵢ=1), the effect is given by the function β(Xⱼ)+Mᵢβ_{α}(Xⱼ). In practice, these functions may be estimated through the use of cubic regression splines (Durrelman, S et al, Stat. Med. 8:551 (1989), which is incorporated herein by reference).

Predictive models may be sought by starting out with a hypothesis (which may be the null model of no marker dependence) and then adding each one out of a specified set of markers to the model in turn. The marker that most improves the p-value of the model is kept, and the process is repeated with the remaining set of markers until the model can no longer be improved by adding a marker. The p-value of a model is defined as the probability of observing a data set as consistent with the model as the actual data when in fact the null-model holds. The resulting model is then checked for any markers with coefficients that are not significantly (at p<0.05) different from zero. Such markers are removed from the model.

For predicting small LDL-C change (CHGL1S) in response to exercise, we started out with the null model, and considered the three categories of variables in Table 5. We arrived at an optimized model, specified in Table 6, containing three markers: baseline small LDL (L1S.1), pre-exercise triglycerides (TGPRE), and two APOE haplotypes (APOE GENE). The model explains 47% of the observed variance for small LDL-C change (CHGL1S) in response to exercise and has a p-value of 4˜10⁻¹³. The p-values for the components are 5·10⁻¹⁴ for L1S.1, 8·10⁻⁹ for TGPRE, 3·10⁻³ for APOE GENE₁, and 6·10⁻² for APOE GENE₂. The correlation between the response predicted by the model vs. the observed response for all subjects can be depicted graphically.

TABLE 5
Predictors of Response to Diet, Exercise and Drugs

| Genetic | Physiological | Demographic |
|---|---|---|
| Genotype alpha | Baseline Factor 1 | Gender |
| (gene A) | | |
| Genotype beta | Baseline Factor 2 | Heredity |
| (gene B) | | |
| Genotype gamma | Baseline Factor 3 | Age |
| (gene C) | | |

TABLE 6
Most predictive linear model of small LDL change due to exercise
CHGL1S˜L1S.1 + TGPRE + APOE GENE
[1] Explains: 46.6%
[1] P-value: 4.23e−013

| | Value | StdErr | t value | Pr(>\|t\|) |
|---|---|---|---|---|
| Intercept | — | 4.1346 | −0.6069 | 5.4530e−001 |
| L1S.1 | — | 0.0832 | −8.7388 | 5.3291e−014 |
| TGPRE | 0.19923 | 0.0316 | 6.2901 | 8.2059e−009 |
| APOEGENE₁ | — | 2.7148 | −3.0293 | 3.1126e−003 |
| APOEGENE₂ | 3.14274 | 1.6655 | 1.88700 | 6.2038e−002 |
| | | 10 | | |

For predicting small HDL-C change (CHGSMHDL) in response to exercise, the initial hypothesis was that the response depends on APOA1 genotype, as discovered in the physiogenomics analysis. We also considered the three categories of variables in Table 5, and constructed an optimized model, specified in Table 7, The model contains three markers: two APOA1 genotypes (APOA1.1), the pre-exercise small HDL cholesterol concentration (SM HDL.1), and the baseline ratio of fat mass to body mass (PERFAT.1). This model explained 43% of the observed variance for small HDL-C change (CHGSMHDL) in response to exercise and had a p-value of 7·10⁻⁸. The p-values for the components are 9·10⁻³ and 9·10⁻¹ for APOA1 genotypes (APOA1.11 and APOA1.12), 1·10⁻⁶ for SM HDL.1, and 3·10⁻² for PERFAT.1. The correlation between the response predicted by the model vs. the observed response for all subjects can be depicted graphically.

TABLE 7
Most predictive linear model of small HDL change due to exercise
CHGSMHDL˜APOA1.1 + SM HDL.1 + PERFAT.1
[1] Explains: 42.7%
[1] P-value: 6.9e−008

| | Value | StdErr | t value | Pr(>\|t\|) |
|---|---|---|---|---|
| Intercept | 4.72843 | 2.140831 | 2.20869 | 3.0520e−002 |
| APOA1.11 | 2.00143 | 0.745134 | 2.68599 | 9.0513e−003 |
| APOA1.12 | 0.14581 | 1.035824 | 0.14077 | 8.8846e−001 |
| SMHDL.1 | −0.48786 | 0.092239 | −5.28914 | 1.3722e−006 |
| PERFAT.1 | 0.18331 | 0.085013 | 2.15632 | 3.45479e−002 |

### Example 6

### Exercise and Markers of Inflammation

The above-described analyses permits the extension of the present examples to additional genes and outcomes. For example, inflammatory markers and their relationship to atherosclerosis are an area of intense interest in clinical medicine. The ability to measure changes in inflammatory markers with exercise training and related genes provides a unique opportunity to examine genes determining the interplay of exercise response and inflammation. The gene probes are derived from candidate genes relevant to energy generation, inflammation, muscle structure, mitochondria, oxygen consumption, blood pressure, lipid metabolism, and behavior, as well as transcription factors potentially influencing multiple physiological axes. The method utilizes blood plasma and DNA from each patient to measure the appropriate genotypes and inflammatory markers in blood.

The inflammatory markers will introduce proteomics to the physiogenomic study of exercise. By profiling at high sensitivity the plasma concentrations of various interleukins, growth factors, and the cellular expression of various receptors, phenotypic components can be added to the analysis. In addition, peripheral white cell monitoring can be included in protocols to demonstrate reporter gene array expression levels. It will also be possible to introduce phenotypic morphometric markers to introduce further bridges between genotype and outcome.

### Example 7

### Development of a Physiogenomic Profile

Table 8 provides an example of personalized healthcare by customizing treatment intervention. In the table, the choices are to recommend a given kind of exercise, drug or diet regimen. If one of the options is high scoring, it can be used on its own. Thus in the example, diet is high scoring in the first patient, a drug in the second, and exercise in the fourth. If the options are midrange, they can be used in combination, as is the case in the third patient, where exercise and diet will each have a positive effect but unlikely to be sufficient independently. If none of the options is high or at least mid-scoring, the physiotype analysis suggests that the patient requires another option not yet in the menu. As more options are built into the menu, the greater the chance that all patients will be served at increased precision of intervention and with optimal outcome.

TABLE 8
Personalized Healthcare by Customizing Intervention
Interventions

| | Physiotype Scores | | |
|---|---|---|---|
| Patient No. | Exercise | Drugs | Diet |
| 1 | 3 | 4 | 7 |
| 2 | 4 | 9 | 5 |
| 3 | 4 | 2 | 5 |
| 4 | 8 | 2 | 3 |

I claim:

1. A physiogenomics method for predicting whether or not a particular treatment regimen will produce a beneficial effect on a patient, comprising, in the first stage, conducting association screening to identify genetic markers and physiological characteristics that have an influence on the disease status of said patient or the response to treatment, wherein said association screening is carried out by the steps of:
(a) identifying significant covariates among demographic data and the other phenotypes and delineating correlated phenotypes by principal component analysis;
(b) performing for each selected genetic marker an unadjusted association test using genetic data, and linear regression for phenotypes reflective of the disease and baseline states of the patient;
(c) using permutation testing to obtain a non-parametric and marker complexity probability (“p”) value for identifying significant markers, wherein significance is shown by a p<0.05; and,
(d) constructing a validated physiogenomic model by linear regression analyses and model parameterization for the dependence of said patient's response to treatment on the markers, wherein a valid model is one with a p<0.05;
(e) identifying one or more genes not associated with a particular outcome in said patient to serve as a physiogenomic control.

2. The method of claim 1, wherein said covariates are determined by generating a covariance matrix for all markers and selecting each significantly correlated markers for use as a covariate in the association test for each marker, wherein serological and baseline outcomes are tested by linear regression.

3. The method of claim 1, wherein said permutation testing correction is conducted by performing the same tests on a large number of data sets that differ from the original by having the response variate permutated at random with respect to the marker, thereby providing a nonparametric estimate of the null distribution of the test statistics, whereby the unpermutated test result in the distribution of permutated test results provides a nonparametric and statistically rigorous estimate of the false positive rate for the marker.

4. The method of claim 3, wherein the number of data sets is 1000, and wherein a marker is selected for model building when the original test ranks in the top 50.

5. The method of claim 1, wherein said linear regression model in the construction of said physiogenomic model has the form of:
$$R = {R}_{0} + {\sum }_{i} {α}_{i} {M}_{i} + {\sum }_{i} {β}_{i} {D}_{i} + ɛ$$
where R is the respective phenotype variable, Mi represents the marker variables, Di are demographic covariates, and ε is the residual unexplained variation, and wherein the model parameters that are to be estimated from the data are Ro, αᵢ and βᵢ.

6. The method of claim 1, wherein said model parameterization is carried out by the maximum likelihood method to obtain optimal estimates of parameters.

7. The method of claim 1, further comprising model refinement by, in the first linear regression model, considering in the first phase a set of simplified models obtained by eliminating each variable in turn and re-optimizing the likelihood function, wherein the ratio between the two maximum likelihoods of the original vs the simplified model provides a significance measure for the contribution of each variable and, in the second phase probabilistic network model, removing dependency links instead of variables.

8. The method of claim 1, wherein said model validation is conducted by cross-validation, wherein said cross-validization comprises the steps of: (a) validating the model by reparameterization using all data except that from one patient; (b) calculating the likelihood of the outcome for this patient from the outcome distribution from the model; (c) repeating the procedure for each patient; (d) calculating the product of all likelihoods; (e) comparing the resulting likelihood with the likelihood of the data from the null model, said null model consiting of no markers and a predicted distribution equal to general distribution; and (f) determining the probability value, wherein if p<0.05 the model is a significant improvement over the null model.

9. The method of claim 1, further comprising the development of the physiotype for a patient with a medical condition, said physiotype consisting of a quantitative profile, said quantitive profile being constructed by combining said physiogenomic information with the patient's clinical and physiological status for each of one or more clinically suitable treatment regimens and assigning a score to each said treatment regimen, and employing said quantitive profile to predict which of said treatment regimen(s) is/are best suited for said patient's medical condition.

10. The method of claim 9, wherein said clinically suitable treatment regimens are selected from the group consisting of drugs, diet and exercise.

11. A printed form, produced from the results of the method of claim 9, for compiling in portable form a patient's physiogenomic treatment profile.
